(19) United States
(12) Patent Application Publication
(10) Pub. No.: US 2025/0042275 A1
(43) Pub. Date: Feb. 6, 2025

(54) CHARGING CONNECTION DEVICE FOR AN ELECTRIC VEHICLE

(71) Applicant: MERCEDES-BENZ GROUP AG, Stuttgart (DE)

(72) Inventors: Mark RENNER, Esslingen (DE); Karina KOHLER, Boeblingen (DE); Juergen BENECKE, Ludwigsburg (DE); Holger STEIN, Arnsberg (DE)

(21) Appl. No.: 18/717,481

(22) PCT Filed: Dec. 2, 2022
(86) PCT No.: PCT/EP2022/084316

§ 371 Date: Jun. 7, 2024

(30) Foreign Application Priority Data
Dec. 9, 2021 (DE) 10 2021 006 064.4

(51) Int. Cl. B60L 53/16; B60L 53/10; H01R 13/447

(52) U.S. Cl. CPC B60L 53/16; H01R 13/447; B60L 53/11

(57) ABSTRACT

A charging connection device, for an electric vehicle having two charging connections arranged next to each other, includes at least two moveably mounted charging connection covers respectively assigned to each charging connection. The charging connection covers respectively cover the corresponding charging connection in at least one first state and at least partially uncover the corresponding charging connection in at least one second state. A barrier arrangement prevents one of the charging connection covers from being transitioned from the at least one first state into the at least one second state if the other charging connection cover has the at least one second state, so that only one of the two charging connections at a time is accessible for contacting, while the other of the two charging connections is covered by the respective charging connection cover.

### BACKGROUND AND SUMMARY OF THE INVENTION

Exemplary embodiments of the invention relate to a charging connection device for an electric vehicle having two charging connections.

DE102021000307A1 discloses a charging connection device for an electric vehicle having two charging connections arranged next to each other, having a first direct current charging connection and a second direct current and/or alternating current charging connection. The charging connection device additionally comprises at least one charging connection cover, which covers at least one of the two charging connections. The charging connection cover is designed such that only one of the two charging connections at a time is accessible for contacting, while the other of the two charging connections is covered by the charging connection cover.

According to the prior art, electric cars require a dedicated charging connection for each charging standard, and therefore two charging connections are also provided in the vehicle for two charging possibilities of different standards.

One charging standard can include charging by direct current, by which is meant charging with direct current, or charging by alternating current, by which is meant charging with alternating current.

A charging standard currently used in Europe is, for example, the so-called Combined Charging System (CCS). Charging with direct current and alternating current is thus possible. A further standard, CHAdeMO=“Charge de Move”, as a standard developed in Japan, offers a charging power of up to 50 kW.

For alternative or future charging standards with powers of several hundred kilowatts or even more with powers of at least one megawatt and more, a further charging connection, in particular a DC voltage connection, is provided according to a further, alternative plug standard. Several charging connections can be electrically interconnected in a path, so that the charging sockets are simultaneously supplied with voltage.

Exemplary embodiments of the invention are directed to an improved charging connection device for an electric vehicle having two charging connections.

Favorable embodiments and advantages of the invention result from the description and the drawings.

According to one aspect of the invention, a charging connection device for an electric vehicle is disclosed having two charging connections arranged next to each other, which are electrically coupled via a shared electrical path, and having at least two moveably mounted charging connection covers, wherein each charging connection is respectively assigned to one of the charging connection covers. The charging connection covers respectively cover the corresponding charging connection in at least one first state and at least partially uncover the corresponding charging connection in at least one second state. A barrier arrangement prevents one of the charging connection covers from being transitioned from the at least one first state into the at least one second state if the other charging connection cover is in the at least one second state, whereby only one of the two charging connections at a time is accessible for contacting, while the other of the two charging connections is covered by the respective charging connection cover. The at least one covered charging connection can thus, in particular, be covered such that it cannot be touched, wherein in particular at least contact elements of the charging connection are covered such that they cannot be touched.

In the following, a charging connection is understood to mean a device, for example a charging socket, which is electrically coupled with an energy storage device and which can be electrically connected to a corresponding plug, which is electrically coupled with a power supply. In the connected state, the energy storage device of the electric vehicle is charged by the power supply.

One of the charging connections can, in particular, be a combined direct current-alternating current charging connection. The other charging connection can be a direct current charging connection or an alternating current charging connection. As an alternative, the charging connection device can also have two direct current connections or two alternating current connections.

Due to a shared-usage electrical path of the two charging connections, it is sufficient to use only one fuse in the electrical architecture of the high-voltage on-board power supply of the vehicle to connect the electrical energy storage device. Costs, installation space, and weight can thus be saved compared to a connection with two fuses. If the two charging connections are arranged in a shared-usage electrical path, both charging connections are simultaneously supplied with voltage.

The respective charging connections are mechanically covered by the charging connection covers.

Due to the charging connection covers and the barrier arrangement, the charging connection device can substantially have three states, wherein in a first state, both charging connections are covered by the respective charging connection cover. In a second state of the charging connection device, one of the charging connections can be covered by the respective charging connection cover and the other can be at least partially uncovered. In a third state, the charging connection that is covered in the second state can be at least partially uncovered, and the charging connection that is at least partially uncovered in the second state can be covered. Thus, it is only possible to plug a charging cable into the corresponding charging connection if the other charging connection is covered with the respective charging connection cover such that it cannot be touched. It can thus be ensured in an advantageous manner that the unused charging connection that is being supplied with voltage is covered such that it cannot be touched while the energy storage device is being charged. In addition, the unused charging connection that is being supplied voltage can advantageously be protected from environmental influences such as dirt or water. In addition, the charging connection covers reliably cover the respective charging connection during the journey or during parking if the vehicle is not charged, and protect the connections from environmental influences and possible touch.

A voltage-free connection of one of the charging connections can advantageously be dispensed with due to the charging connection covers and the barrier arrangement. A corresponding changeover device, a so-called switch box, can thus be dispensed with, whereby additional costs and additional installation space can be saved.

According to an advantageous embodiment of the charging connection device, the barrier arrangement can comprise at least one locking element that locks a corresponding charging connection cover in the at least one first position. In addition, or as an alternative, the barrier arrangement can comprise at least one blockade arrangement that blocks a drive that drives at least one of the charging connection covers. Due to the at least one locking element and/or due to the at least one blockade arrangement, the charging connection cover that is in the first state can advantageously be prevented from moving into the second state, or it can at least be made more difficult for it to move into the second state, if the other charging connection cover is in one of the second states. The locking element can be designed in this case as a locking pin, for example, which mechanically locks the corresponding charging connection cover. This locking pin can be moved between a locked position and an unlocked position via a suitable arrangement. Manually opening by hand the corresponding charging connection cover locked by the locking element can be prevented or made more difficult by the locking element, and in addition, using a suitable drive to mechanically open the corresponding charging connection cover locked by the locking element can be prevented or made more difficult. In the blocking state, the blockade arrangement can mechanically block the at least one drive driving the charging connection covers. As an alternative or in addition, in the blocking state, the blockade arrangement can act on a mechanical force transmission path between the drive and the corresponding charging connection cover to block the latter, or to decouple it from the charging connection cover. In addition, it would be conceivable via the blockade arrangement in the blocking state to interrupt a power feed for a drive designed as an electric motor. Due to the blockade arrangement, the charging connection cover in the first state can be prevented from being transitioned via the drive into one of the second states, or this can be made more difficult. In addition, a manual opening of the corresponding charging connection cover by hand can also be made more difficult or prevented by force resistance. This can be possible in a controlled manner by sensors and actuators, but can also be implemented passively by simple mechanical functions.

According to an advantageous embodiment of the charging connection device, at least one sensor arrangement coupled with the barrier arrangement can monitor the state of the charging connection covers. The at least one sensor arrangement can thus comprise a limit switch and/or an optical sensor and/or a camera and/or a path measurement system or potentiometer. The at least one sensor arrangement thus receives first sensor data dependent on the state of a first charging connection cover and second sensor data dependent on the state of a second charging connection cover. Via the coupling with the barrier arrangement, depending on the received sensor data, the barrier arrangement can prevent the first charging connection cover from being transitioned from the at least one first state into the at least one second state, or prevent the second charging connection cover from being transitioned from the at least one first state into the at least one second state.

According to an advantageous embodiment of the charging connection device, the blocking arrangement can comprise a coupling arrangement, which couples the charging connection cover of one charging connection with the charging connection cover of the other charging connection. The coupling arrangement can thus be designed mechanically or electrically. In the case of the transition from the at least one first state into the at least one second state of the one charging connection cover, the other charging connection cover can be blocked by the coupling arrangement for a change of state. In the case of a transition from the at least one second state into the at least one first state, the other charging connection can be uncovered by the coupling arrangement for a change of state.

According to an advantageous embodiment of the charging connection device, the two charging connections can be arranged in a shared charging well or in two separate charging wells that are, in particular, arranged next to each other. In the case of an arrangement in a shared charging well, the charging connections can be arranged on the vehicle in a space-saving manner. In the case of an arrangement in separate charging wells, the positioning of the charging connection can be configured more flexibly.

According to an advantageous embodiment of the charging connection device, at least one charging well can comprise at least one cover element, which covers the corresponding charging well in at least one first state, and at least partially uncovers the corresponding charging well in at least one second state. Via the additional cover element, the charging connection arranged in the charging well and its charging connection cover can be additionally covered and protected from dirt or moisture and/or snow. In the case of an arrangement of the charging connections in a shared charging well, both charging connections and their charging connection covers can be covered or at least partially uncovered by the same cover element. The cover element can be arranged on a side of the corresponding charging well.

According to an advantageous embodiment of the charging connection device, at least one of the two charging connection covers and/or at least one cover element can be designed as a flap that is mounted such that it can be rotated and/or moved translationally. The flap can thus be folded or pivoted upwards or downwards or to the side or diagonally outwards on a suitable axis, away from the respective charging connection or from the charging well, in order to be moved into one of the second states. For example, the flap can be arranged in a similar manner as a usual fuel flap on the side of the charging well or on the side of the charging connection, which can correspond to the fuel well arranged in a combustion vehicle. As an alternative, the flap can be rotated in a plane in parallel with the charging well. As an alternative, the flap can be shifted upwards or downwards or to the side via a corresponding guide in order to be moved into one of the second states. The respective flap can thus be shifted outwards in front of an outer body shell or can be shifted inwards under the outer body shell in order to be moved into one of the second states. A combination of pivoting and rotating or of pivoting and shifting or of rotating and shifting is also conceivable. In addition, the charging connection covers can be moved in different ways. For example, a first charging connection cover can be pivoted, and a second charging connection cover can be shifted. As an alternative, the opening mechanism of both charging connection covers can be designed identically or such that they mirror each other. Furthermore, the cover element can be moved differently than at least one of the charging connection covers. As an alternative, the cover element can be designed identically to the opening mechanism of at least one of the charging connection covers or such that it mirrors it.

According to an advantageous embodiment of the charging connection device, at least one of the charging connection covers and/or at least one cover element can be designed as a roller shutter that can be folded or rolled up or bent. The roller shutter can be formed from plastic or sheet metal. This roller shutter can be formed as one part, or the roller shutter can have several slats. In the foldable embodiment or the embodiment formed from slats, the roller shutter can be folded up or unfolded in order to be moved into one of the first states or one of the second states. In the rollable embodiment, the roller shutter can be rolled up and unrolled, in order to be moved into one of the first states or one of the second states. In the bendable embodiment, the roller shutter can be folded away inwards or outwards or to the side out of the first state in order to be moved into one of the second states. Furthermore, an inwardly retracting arrangement, like a central console cover or an S-shaped arrangement that folds away inwards, is conceivable. As a further embodiment, slats and roller shutter systems and bendable embodiments are also possible, which can roll away at least at an angle. A bendable metal sheet, for example a spring metal sheet, which does not have individual slats, can thus also be bent away and/or be pushed away around a corner or an angle. The movements between the states of the roller shutter can be performed upwards, downwards, to the left or right.

According to an advantageous embodiment of the charging connection device, at least one of the charging connection covers and/or at least one cover element can comprise several cover elements that can be pushed together or pushed apart. A closing mechanism similar to that of an aperture or a shutter of a camera can be implemented here.

According to an advantageous embodiment of the charging connection device, the two charging connections can be connected in parallel in the shared electrical path. Installation space, costs and weight can be saved by the shared charging path. In addition, an adjustment of the charging connection device to an installation space that is frequently delimited behind the charging connection is possible, because separating elements are not required.

Using the charging connection device according to the invention, it can advantageously be ensured that only one charging connection at a time is accessible for contacting, and the other charging connection is respectively covered such that it cannot be touched.

Further advantages result from the following description of drawings. An exemplary embodiment of the invention is depicted in the drawings. The drawings, the description and the claims contain numerous features in combination. The person skilled in the art will also expediently consider the features individually and combine them to form logical further combinations.

### BRIEF DESCRIPTION OF THE DRAWING FIGURES

The drawings show:

FIG. 1 a charging connection device for an electric vehicle having two charging connections according to a first exemplary embodiment of the invention having completely covered charging connections;

FIG. 2 the charging connection device according to FIG. 1 having an uncovered charging connection;

FIG. 3 a charging connection device for an electric vehicle having two charging connections according to a second exemplary embodiment of the invention having completely covered charging connections;

FIG. 4 the charging connection device according to FIG. 3 having an uncovered charging connection;

FIG. 5 a charging connection device for an electric vehicle having two charging connections according to a third exemplary embodiment of the invention having completely covered charging connections; and

FIG. 6 the charging connection device according to FIG. 5 having an uncovered charging connection.

Identical or the same kind of components are denoted with the same reference numerals in the figures. The figures only show examples, and should not be understood as restrictive.

### DETAILED DESCRIPTION

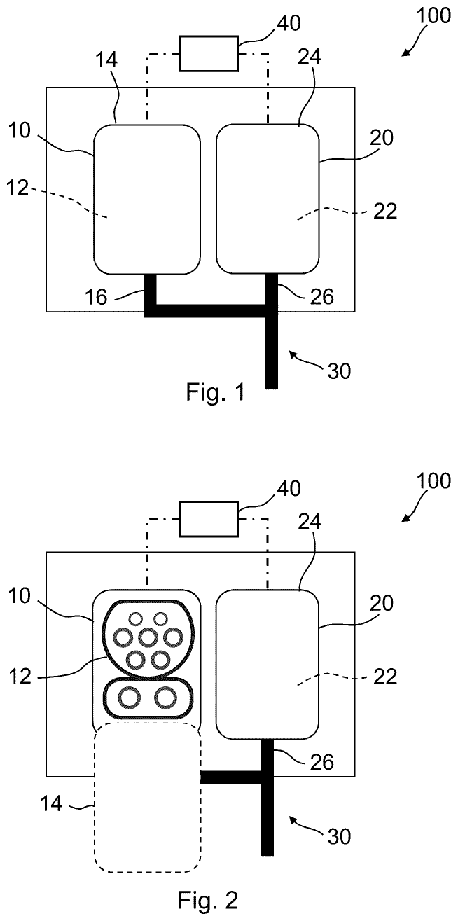

FIGS. 1 and 2 show a charging connection device 100 for an electric vehicle having two charging connections 12, 22 according to a first exemplary embodiment of the invention.

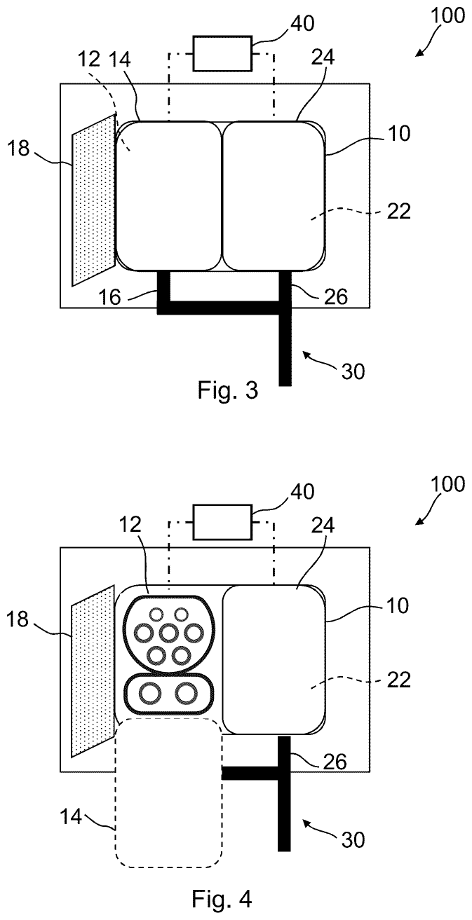

FIGS. 3 and 4 show a charging connection device 100 for an electric vehicle having two charging connections 12, 22 according to a second exemplary embodiment of the invention.

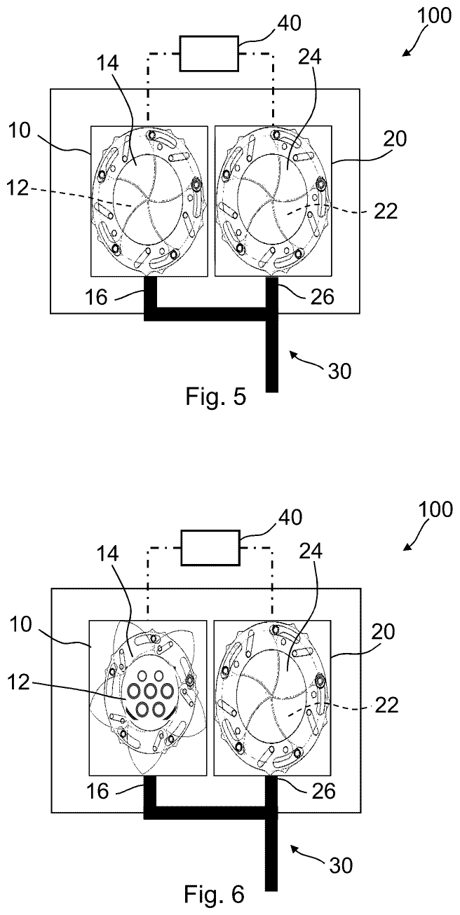

FIGS. 5 and 6 show a charging connection device 100 for an electric vehicle having two charging connections 12, 22 according to a third exemplary embodiment of the invention.

In the following, the commonalities of the depicted exemplary embodiments of the charging connection devices 100 are first explained, and subsequently, the differences between the depicted charging connection devices 100 are explained.

As can be seen from FIGS. 1 to 6, the depicted exemplary embodiments of the charging connection devices 100 for an electric vehicle respectively comprise two charging connections 12, 22 arranged next to each other.

As can further be seen from FIGS. 2, 4 and 6, the charging connections 12, 22 correspond to charging sockets, but other suitable charging connections 12, 22 are also conceivable. As can further be seen from FIGS. 2 and 4, and as is also indicated, but not completely depicted in FIG. 6, a charging connection 12 arranged on the left in the corresponding exemplary embodiment of the charging connection device 100 is designed as a combined direct current-alternating current charging connection 12. This can for example be a so-called CCS charging standard (Combined Charging System). The charging connection 22 arranged on the right can be designed as a direct current charging connection 22 or as an alternating current charging connection 22 or as a further combined direct current-alternating current charging connection 22.

In a further exemplary embodiment (not depicted), both of the charging connections 12, 22 can be designed as a direct current connection, or both of the charging connections 12, 22 can be designed as an alternating current connection.

Naturally, the designation left and right is exemplary. The depicted combined direct current-alternating current charging connection 12 can naturally also be arranged on the right. The charging connections 12, 22 can further also be arranged offset from one another or one below the other.

As can further be seen from FIGS. 2, 4 and 6, the charging connections 12, 22 are electrically coupled via a shared electrical path 30. The two charging connections 12, 22 arranged next to each other in the shared electrical path 30 are connected in parallel. Each charging connection 12, 22 thus respectively has an electrical coupling 16, 26. No separating elements are thus required to separate the charging connections 12, 22. The two charging connections 12, 22 are being supplied with voltage.

As can be seen from FIGS. 1 to 6, the depicted exemplary embodiments of the charging connection devices 100 further comprise at least two moveably mounted charging connection covers 14, 24, wherein each charging connection 12, 22 is respectively assigned to one of the charging connection covers 14, 24. The charging connection covers 14, 24 are respectively mounted moveably between a first end position and a second end position. Several intermediate positions between the end positions are possible, whereby in some intermediate positions, the charging connection covers 14, 24 cover the charging connection cover 12, 22 assigned to them, in particular completely, and in several further intermediate positions, the charging connection covers 14, 24 at least partially or completely uncover the charging connection 12, 22 assigned to them. States of the charging connection covers 14, 24 can thus be defined, whereby the charging connection covers 14, 24 cover the corresponding charging connection 12, 22 in at least one first state and at least partially uncover the corresponding charging connection 12, 22 in at least one second state.

As can further be seen from FIGS. 1 to 6, a barrier arrangement 40 prevents one of the charging connection covers 14, 24 from being transitioned from the at least one first state into the at least one second state if the other charging connection cover 14, 24 is in the at least one second state. Only one of the two charging connections 12, 22 at a time is thus accessible for contacting, while the other of the two charging connections 12, 22 is covered by the respective charging connection cover 14, 24, in particular covered such that it cannot be touched. At least contact elements of the respectively inaccessible charging connection 12, 22 can thus be covered such that they cannot be touched.

As can further be seen from FIGS. 1 to 6, the charging connection device 100 substantially has three states due to the charging connection covers 14, 24 and the barrier arrangement 40. In a first state (FIG. 1, 3, 5) of the charging connection device 100, both of the charging connections 12, 22 are covered by the respective charging connection cover 14, 24. In a second state (FIG. 2, 4, 6) of the charging connection device 100, one of the charging connections 22 is covered by the respective charging connection cover 24, and the other charging connection 12 is at least partially uncovered by the charging connection cover 14. In a third state (not depicted) of the charging connection device 100, the charging connection 22 that is covered in the second state can be at least partially uncovered, and the charging connection 12 that is at least partially uncovered in the second state is covered. In the depicted exemplary embodiment, the uncovered charging connections 12 are completely uncovered in the second and in the third (not depicted) state, but an only partial uncovering of the charging connections 12, 22 is also conceivable. A maximum of one of the charging connections 12, 22 can be accessed via this arrangement. Thus, it is only possible to plug a charging cable into the corresponding charging connection 12, 22 if the other charging connection 12, 22 is covered with the respective charging connection cover 14, 24 such that it cannot be touched. It is thus ensured that the unused charging connection 22 that is being supplied with voltage is covered such that it cannot be touched during charging. In addition, the unused charging connection 22 that is being supplied with voltage is protected from environmental influences such as dirt or water.

The barrier arrangement 40 (not depicted in more detail) can comprise at least one locking element in an exemplary embodiment of the charging connection device 100, which locking element locks a corresponding charging connection cover 14, 24 in the at least one first position. As an alternative or in addition, the barrier arrangement 40 can comprise at least one blockade arrangement, which blocks a drive that drives at least one of the charging connection covers. The locking element can be a locking pin, which can be moved between a locked position into an unlocked position. The respective charging connection cover 14, 24 can be mechanically locked by the locking pin. A mechanical blockade of the drive or of a mechanical force transmission path between the drive and the respective charging connection cover 14, 24 can be implemented by the blockade arrangement. The mechanical force transmission path between the respective charging connection cover 14, 24 and the corresponding drive can furthermore be decoupled, or the current supply to the corresponding, electric drive can be interrupted.

A possible implementation can be possible in a controlled manner via sensors and actuators. In addition, or as an alternative, a passive implementation via simple mechanical functions is also possible.

For the controlled implementation, the charging connection device 100 can comprise at least one sensor arrangement coupled with the barrier arrangement 40, the sensor arrangement monitoring the state of the charging connection covers 14, 24. The sensor arrangement can comprise a limit switch and/or an optical sensor and/or a camera and/or a path measurement system or potentiometer. A suitable evaluation unit recognizes which cover is open via the sensor arrangement, and controls the locking element or the blockade arrangement accordingly. This can be implemented mechanically via suitable actuators or electrically via suitable elements.

For passive implementation, the charging connection device 100 can comprise a coupling arrangement, which couples the charging connection cover 14, 24 of a charging connection 12, 22 with the charging connection cover 24, 14 of the other charging connection 22, 12. The charging connection covers 14, 24 can be coupled with each other via the coupling arrangement such that when a charging connection cover 14 moves, for example to uncover the charging connection 12 in question to plug in a charging plug, the other charging connection cover 24 is moved such that the corresponding charging connection 14 is covered and vice versa.

As an alternative or optionally, the charging connection covers 14, 24 can be coupled with a locking element or a blockade arrangement, which locks or blocks the respective other charging connection covers 24, 14. The charging connection covers 14, 24 can be coupled with the locking element of the other charging connection covers 24, 14 via the coupling arrangement such that when a charging connection cover 14 moves, for example to uncover the charging connection 12 in question to plug in a charging plug, the locking element of the other charging connection cover 24 is moved such that the other charging connection cover 24 is locked. As an alternative, the charging connection covers 14, 24 can be coupled with the blockade arrangement of the other charging connection covers 24, 14 via the coupling arrangement such that when a charging connection cover 14 moves, for example to uncover the charging connection 12 in question to plug in a charging plug, the blockade arrangement of the other charging connection cover 24 is moved such that the drive or a force transmission path of the other charging connection cover 24 is blocked. This can be done mechanically and/or electrically.

The first exemplary embodiment depicted in FIGS. 1 and 2 and the third exemplary embodiment depicted in FIGS. 5 and 6 of the charging connection device 100 differ from the second exemplary embodiment depicted in FIGS. 3 and 4 in that the charging connections 12, 22 are arranged in two separate charging wells 10, 20 that are in particular located next to each other. The charging wells 10, 20 can be arranged separately from each other, and be internally electrically connected, with the same voltage being applied to both of the charging connections 12, 22. In an alternative embodiment (not depicted) of the charging connection device 100, at least one charging well 10, 20 can additionally comprise at least one cover element 18. The cover element 18 can cover the corresponding charging well 10, 20 in at least one first state and at least partially uncover the corresponding charging well 10, 20 in at least one second state. This cover element 18 can cover the corresponding charging connection 12, 22 and its charging connection cover 14, 24.

As can further be seen from FIGS. 3 and 4, in the second exemplary embodiment of the charging connection device 100, the two charging connections 12, 22 are arranged in a shared charging well 10 and are electrically connected, with the same voltage being applied to both of the charging connections 12, 22. An additional cover element 18 is provided, which covers the charging well 10 in a first state, and at least partially uncovers the charging well 10 in at least one depicted second state. In the first state, the cover element 18 covers the charging well 10 and each charging connection 12, 22. The depicted cover element 18 is pivotably mounted on an axis that runs on the left side of the charging well 10, in a similar manner to known fuel caps. In an alternative exemplary embodiment (not depicted), the cover element 18 can also be pivotably mounted on another suitable axis. In addition, in an alternative embodiment, the cover element 18 can be shiftably mounted. In an alternative embodiment, the cover element 18 can furthermore be designed as a roller shutter that can be folded or rolled up or bent. In addition, in an alternative embodiment, the cover element 18 can comprise several cover elements that can be pushed together or pushed apart, similar to a shutter or an aperture of a camera. In addition, it is possible to dispense with covering the charging well 10 with an additional cover element 18.

As can further be seen from FIGS. 1 to 4, in the first and in the second exemplary embodiment of the charging connection device 100, the two charging connection covers 14, 24 are designed as flaps mounted such that they can be moved translationally. In the depicted exemplary embodiments of the charging connection device 100, the flaps can be shifted downwards to uncover the corresponding charging connection 12, 22, and can be shifted upwards to cover the corresponding charging connection 12, 22. Naturally, a shift in other spatial directions is also conceivable. The charging connection covers 14, 24 can furthermore be shifted in different directions to uncover the corresponding charging connection 12, 22. For example, one charging connection cover 14 can be shifted to the left and the other charging connection cover 24 can be shifted to the right. In the depicted exemplary embodiments, the charging connection covers 14, 24 are shifted in front of the outer body shell, but shifting behind the outer body shell would also be possible.

In an alternative exemplary embodiment (not depicted) of the charging connection device 100, at least one of the two charging connection covers 14, 24 can be designed as a flap that is mounted such that it can be rotated. This flap can be pivoted or folded forwards at a suitable axis. A combination of a translational and a rotational movement of the flap is furthermore conceivable.

One flap can furthermore be shiftably mounted and one flap can be pivotably or rotatably mounted.

In a further exemplary embodiment (not depicted) of the charging connection device 100, at least one of the charging connection covers 14, 24 can be designed as a roller shutter that can be folded or rolled up or bent. This roller shutter can be formed from plastic or sheet metal, which can be rolled up, folded or retracted inwards. In addition, the roller shutter can fold inwards in an S shape. The movement can be performed upwards, downwards, to the left, or to the right. The roller shutter can be designed as an arrangement of slats or as a spring metal sheet that can be bent. Slats and roller shutter systems that can be rolled up or at least rolled away at an angle can be conceived as further options. In addition, the option is also conceivable of designing the roller shutter as a metal sheet that can be bent, said metal sheet having no individual slats, but also being able to be bent away or pushed away at a corner or at an angle.

As can further be seen from FIGS. 5 and 6, in the third exemplary embodiment of the charging connection device 100, the two charging connection covers 14, 24 comprise several cover elements that can be pushed together or pushed apart. The closing mechanism is comparable in this case with the shutter or the aperture of a camera.

In an exemplary embodiment (not depicted) of the charging connection device 100, one of the charging connection covers 14, 24 can comprise several cover elements that can be pushed together or pushed apart, and the other charging connection cover 24, 14 can be designed as a moveably mounted flap or as a moveably mounted roller shutter.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 charging well
12 charging connection
14 charging connection cover
16 electrical coupling
18 cover element
20 charging well
22 charging connection
24 charging connection cover
26 electrical coupling
30 electrical path
40 barrier arrangement
100 charging connection device

1-10. (canceled)

11. A charging connection device for an electric vehicle, the charging connection device comprising:
two charging connections arranged next to each other and electrically coupled via a shared electrical path, wherein the two charging connections are charging sockets and include a combined direct current-alternating current charging connection, and a direct current charging connection or an alternating current charging connection;
at least two movably mounted charging connection covers, wherein each of the at least two movably mounted charging connections is respectively assigned to one of the two charging connection covers,
wherein the two charging connection covers respectively cover a corresponding one of the two charging connections in at least one first state and at least partially uncover the corresponding one of the two charging connections in at least one second state,
wherein a barrier arrangement prevents one of the at least two movably mounted charging connection covers from being transitioned from the at least one first state into the at least one second state when the other charging connection cover is in the at least one second state, so that only one of the two charging connections is accessible for contacting at a time, while another of the two charging connections is covered by the respective one of the two charging connection covers such that the another of the two charging connections cannot be touched, wherein, at least contact elements of the respectively inaccessible charging connection are covered such that the contact elements cannot be touched,
wherein at least one of the at least two movably mounted charging connection covers or at least one cover element is a flap, which is mounted such that that the two movably mounted charging connection covers or the at least one cover element is rotatable or translationally movable.

12. The charging connection device of claim 11, wherein the barrier arrangement comprises:
at least one locking element configured to lock a corresponding one of the at least two movably mounted charging connection covers in the at least one first position, or
at least one blockade arrangement configured to block a drive configured to drive at least one of the at least two movably mounted charging connection covers.

13. The charging connection device of claim 11, further comprising:
at least one sensor arrangement coupled with the barrier arrangement and configured to monitor a state of the at least two movably mounted charging connection covers.

14. The charging connection device of claim 11, wherein the barrier arrangement comprises a coupling arrangement configured to couple one of the at least two movably mounted charging connection covers of a first one of the two charging connections with another one of the at least two movably mounted charging connection covers of a second one of the two charging connections.

15. The charging connection device of claim 11, wherein the two charging connections are arranged in a shared charging well or in two separate charging wells that are arranged next to each other.

16. The charging connection device of claim 15, wherein the at least one cover element covers a corresponding one of the two separate charging wells in the at least one first state, and at least partially uncovers another corresponding one of the two separate charging wells in the at least one second state.

17. The charging connection device of claim 11, wherein at least one of the two movably mounted charging connection covers or the at least one cover element is a roller shutter configured to be folded, rolled-up, or bent.

18. The charging connection device of claim 11, wherein at least one of the two movably mounted charging connection covers or the at least one cover element comprises several cover elements configured to be pushed together or pushed apart.

19. The charging connection device of claim 11, wherein the two charging connections are connected in parallel in the shared electrical path.
